(19) United States
(12) Patent Application Publication
(10) Pub. No.: US 2017/0220026 A1
(43) Pub. Date: Aug. 3, 2017

(54) DIRECT CONTACT INSTRUMENT CALIBRATION SYSTEM

(71) Applicant: Bio-Rad Laboratories, Inc., Hercules, CA (US)

(72) Inventors: Richard Tighe, Half Moon Bay, CA (US); Damon V. Williams, Pleasanton, CA (US); Samuel J. Evans, Danville, CA (US)

(21) Appl. No.: 15/422,213

(22) Filed: Feb. 1, 2017

Related U.S. Application Data
(60) Provisional application No. 62/289,908, filed on Feb. 1, 2016.

(51) Int. Cl. G05B 19/401; G01D 5/14

(52) U.S. Cl. CPC G05B 19/4015; G01D 5/14; G05B 2219/41092

(57) ABSTRACT

Systems and methods for calibrating an instrument having a tool and a work surface. An exemplary instrument may comprise a support member including a conductive surface. The instrument also may comprise a fluid-transport device including a conductive tube having an open end. A drive mechanism of the instrument may include a motor operable to drive movement of the surface and the tube relative to one another along an axis and into contact with one another. A circuit of the instrument may include a voltage source and the tube. A control module may be configured to calibrate a relationship between the drive mechanism and a position of the tube and/or surface along the axis based on a sensed change in an electrical property of the circuit that occurs when the tube and the surface contact one another.

### CROSS-REFERENCE TO PRIORITY APPLICATION

This application is based upon and claims the benefit under 35 U.S.C. §119(e) of U.S. Provisional Patent Application Ser. No. 62/289,908, filed Feb. 1, 2016, which is incorporated herein by reference in its entirety for all purposes.

### CROSS-REFERENCES TO OTHER MATERIALS

The following related applications and materials are incorporated herein, in their entireties, for all purposes: U.S. Pat. No. 7,041,481, issued May 9, 2006; U.S. Patent Application Publication No. 2010/0173394 A1, published Jul. 8, 2010; U.S. Patent Application Publication No. 2012/0152369 A1, published Jun. 21, 2012; U.S. Patent Application Publication No. 2012/0190032 A1, published Jul. 26, 2012; U.S. Patent Application Publication No. 2012/0194805 A1, published Aug. 2, 2012; U.S. patent and Joseph R. Lakowicz, PRINCIPLES OF FLUORESCENCE SPECTROSCOPY (2nd Ed. 1999).

### FIELD

This disclosure relates to systems and methods for calibrating instruments using automatic processes to directly determine a mechanical relationship between a tool and a work surface.

### INTRODUCTION

Instruments are typically calibrated using sensors on motion axes to provide fixed reference points. Calibration typically requires a calibration mode and/or personnel having specialized training. Accordingly, calibration may be performed only infrequently, generally in the factory or during service calls by technicians. Accordingly, a need exists for improved and automatic calibration methods and systems.

### SUMMARY

Systems and methods are provided for calibrating an instrument having a tool and a work surface. An exemplary instrument may comprise a support member including a conductive surface. The instrument also may comprise a fluid-transport device including a conductive tube having an open end. A drive mechanism of the instrument may include a motor operable to drive movement of the surface and the tube relative to one another along an axis and into contact with one another. A circuit of the instrument may include a voltage source and the tube. A control module may be configured to calibrate a relationship between the drive mechanism and a position of the tube or the surface along the axis based on a sensed change in an electrical property of the circuit that occurs when the tube and the surface contact one another.

### BRIEF DESCRIPTION OF THE DRAWINGS

FIG. 1 is a schematic block diagram of an illustrative instrument having a direct contact calibration system in accordance with aspects of the present disclosure.

FIG. 2 is a circuit diagram of an illustrative voltage divider circuit and comparator circuit in accordance with aspects of the present disclosure.

FIGS. 3-5 are circuit diagrams showing an illustrative voltage divider circuit including aspects of the instrument of FIG. 1.

FIGS. 6-7 are schematic diagrams showing different embodiments of the comparator circuit of FIG. 2.

FIG. 8 is a flow chart depicting steps of an illustrative process for calibrating an instrument having a direct contact calibration system.

### DESCRIPTION

### Overview

Various aspects and examples of a direct-contact instrument calibration system, and related methods, are described below and illustrated in the associated drawings. Unless otherwise specified, a direct-contact instrument calibration system and/or its various components may, but are not required to, contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

Certain instruments and devices require precise calibration of tools with respect to work surfaces. For example, pick-and-place operations, pipetting from discrete reservoirs, and similar activities require accurate alignment between a tool or end effector and the work surface on or near which it operates. In general, a direct-contact instrument calibration system may include electrical and electronic circuits and/or software modules configured to monitor a conductive tool for indications of contact with a grounded work surface. Using the general concept of a resistive voltage divider circuit, detection of contact between the tool and the work surface can then be used to calibrate one or more motor controllers on one or more axes. This method facilitates automatic calibration of an instrument or other device, thereby improving efficiency, accuracy, and precision.

Aspects of a direct-contact instrument calibration system and/or method may be embodied as a computer method, computer system, or computer program product. Accordingly, aspects of the direct-contact instrument calibration system may take the form of an entirely hardware embodiment, an entirely software embodiment (including firmware, resident software, micro-code, and the like), or an embodiment combining software and hardware aspects, any of which may generally be referred to herein as a “circuit,” “module,” or “system.” Furthermore, aspects of the direct-contact instrument calibration system may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of the direct-contact instrument calibration system may be written in one or any combination of programming languages, including an object-oriented programming language such as Java, Smalltalk, C++, and/or the like, and conventional procedural programming languages, such as C. Mobile apps may be developed using any suitable language, including those previously mentioned, as well as Objective-C, Swift, C#, HTML5, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the direct-contact instrument calibration system are described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer-readable medium that can direct a computer, other programmable data processing apparatus, and/or other device to function in a particular manner, such that the instructions stored in the computer-readable medium produce an article of manufacture including instructions which implement the function/act specified in the flowchart and/or block diagram block or blocks.

The computer program instructions can also be loaded onto a computer, other programmable data processing apparatus, and/or other device to cause a series of operational steps to be performed on the device to produce a computer-implemented process such that the instructions which execute on the computer or other programmable apparatus provide processes for implementing the functions/acts specified in the flowchart and/or block diagram block or blocks.

Any flowchart and/or block diagram in the drawings is intended to illustrate the architecture, functionality, and/or operation of possible implementations of systems, methods, and computer program products according to aspects of the direct-contact instrument calibration system described herein. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### Examples, Components, and Alternatives

The following sections describe selected aspects of exemplary direct-contact instrument calibration systems, as well as related systems and/or methods. The examples in these sections are intended for illustration and should not be interpreted as limiting the entire scope of the present disclosure. Each section may include one or more distinct inventions, and/or contextual or related information, function, and/or structure.

Illustrative Calibration System:

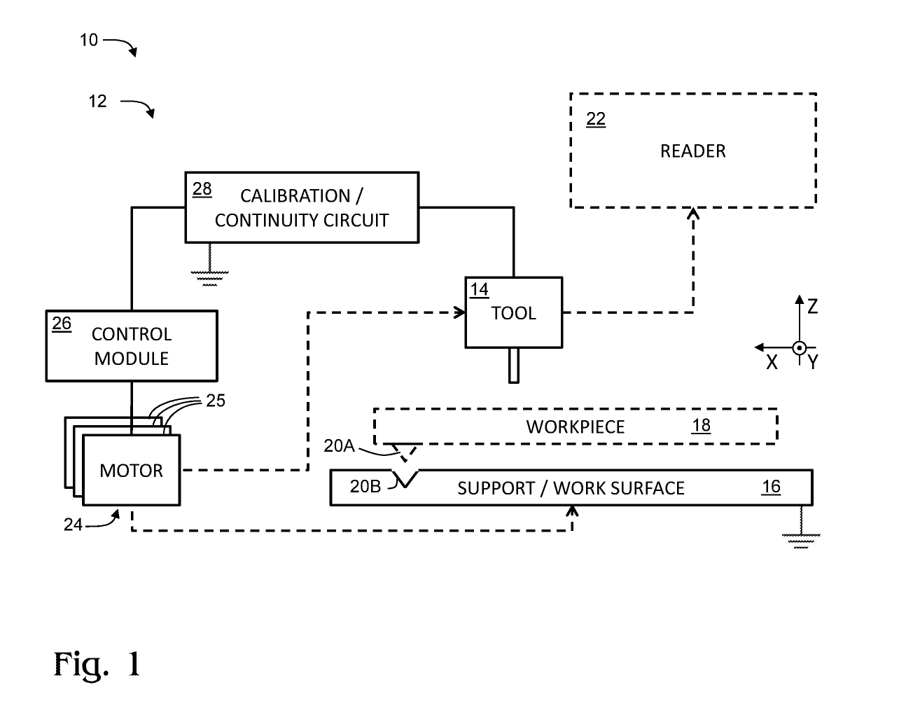

As shown in FIG. 1, this section describes an instrument having a direct contact calibration system. This system is an example of the direct-contact calibration system described generally above.

FIG. 1 is a schematic diagram of an instrument 10 having a direct contact calibration system 12. Instrument 10 may include any suitable electronic instrument having a controlled, at least partially conductive tool 14 requiring calibration to a controlled, grounded work surface 16. In this context, control includes controlled movement on one or more axes and/or maintaining a fixed location, such that tool 14 and/or work surface 16 may remain stationary during operation. In some examples, instrument 10 may include a droplet generator instrument and/or a droplet reader instrument, which alone or together may be used for digital polymerase chain reaction (PCR) assays performed with droplets. Such instruments may include a tool having a conductive needle, and a work surface having a conductive stage. Alternatively, or in addition, such instruments may include a tool that is a pipettor having an electrically conductive inlet/outlet tube, and a support member with a work surface that provides an electrically conductive deck to support a sample holder.

FIG. 1 shows that tool 14 and work surface 16 are movable relative to one another. More specifically, tool 14, work surface 16, or both, may be movable with respect to one or more of the X, Y, and Z axes. For simplification, the following description assumes that tool 14 remains stationary while work surface 16 is moved in a controlled fashion relative to the tool along any or all of the X, Y, or Z axes.

In some embodiments, tool 14 may be a fluid-transport device that drives movement of fluid. The movement may be into and/or out of the fluid-transport device. Accordingly, tool 14 may be a fluid-transport device structured as a pipettor having a port at which fluid is aspirated into the device and/or dispensed from the device. The fluid-transport device may include a source of negative/positive pressure (e.g., at least one pump) and a needle operatively connected to the pressure source. The needle may be hollow to form a tube, which may have an open end forming an entry/exit port of the device. The open end may be a bottom end of the tube. At least a portion of the tube may be electrically conductive, and thus formed of metal or another conductive material. Work surface 16 may be manipulated to bring one or more locations on the work surface within a certain proximity of the tip of tool 14.

A workpiece 18 may be supported by work surface 16. For example, workpiece 18 may include a sample holder or cartridge having various reservoirs, such as at least one well or an array of wells, which may contain liquid (e.g., emulsions). Tool 14 may be a pipettor with a tube used to remove liquid contents of the reservoirs. Accordingly, work surface 16, while supporting a sample holder, may be brought to appropriate positions near tool 14, such that the bottom end of the tube is inserted into respective wells of workpiece 18, and into contact with liquid therein. A vacuum produced in the pipettor may aspirate liquid from each well into the tube of the pipettor, and optionally through a detection zone of a channel at which a signal may be detected from the liquid.

To facilitate positive location of such a workpiece, complementary registration features 20A, 20B may be included on workpiece 18 and work surface 16. Registration features 20A, 20B may include any suitable complementary structures configured to positively locate workpiece 18 (and features thereof, such as wells) relative to work surface 16. In some examples, registration features 20A, 20B may include a male protrusion configured to mate with a female receptacle. In some examples, registration features 20A, 20B may include a ridge configured to seat in a corresponding channel. In some examples, a portion of the workpiece, such as an emulsion well, may be seated in an aperture of the work surface. Registration features 20A, 20B facilitate the ability of system 12 to accurately position tool 14 with respect to features (such as wells) of a properly mated workpiece. The workpiece need not be conductive, because the instrument can be calibrated using the conductive work surface. This calibration may be performed before the workpiece has been placed onto the work surface. In some cases, the calibration must be performed in the absence of the workpiece, if the operatively placed workpiece obstructs contact between the tool and the work surface. In any event, the positions or coordinates of features of the workpiece, once operatively placed on the work surface, may be assumed or interpolated/extrapolated, as the case may be.

Tool 14 may include any suitable end effector, probe, needle, pipette, manipulator, or other tool configured to interact with the work surface or a workpiece thereon, where at least a portion of the tool is electrically conductive. Tool 14 may have a low electrical resistance with respect to a specific resistive element of calibration system 12, further described below. Tool 14 may be operatively connected to a portion of instrument 10 that conducts further handling or analysis functions. For example, tool 14 may comprise a pipettor in fluid communication with a droplet reader apparatus 22 to which liquids are conveyed for further analysis.

Work surface 16 may include any suitable support surface having at least a portion that is conductive and capable of being grounded. Work surface 16 may be controllably movable in one or more directions, i.e., on one or more axes. In other examples, work surface 16 may be fixed or stationary, at least with respect to the tool. In some examples, work surface 16 comprises a metal stage.

The support member providing work surface 16 may have any suitable structure. In some embodiments, the support member may include a metal plate or block having a horizontal top surface region, which may be substantially planar and/or rectangular, and a plurality of lateral surface regions extending downward, optionally vertically, from the top surface region. The lateral surface regions may at least partially form four respective sides of the support member. A first pair of the lateral surface regions may be parallel to one another and orthogonal to a second pair of the lateral surface regions. The top surface region and the lateral surface regions collectively may form at least part of a conductive exterior work surface of the support member. An end of tool 14 may contact the top surface region of the support member when the instrument is being calibrated along the Z axis. A lateral side of tool 14 near the end may contact an appropriate one of the lateral surface regions of the support member when the instrument is being calibrated along the X axis or the Y axis.

As described briefly above, one or both of the tool and work surface may be controllably movable parallel to the X, Y, and/or Z axis. For example, a drive mechanism 24 including at least one drive motor 25 may be coupled to tool 14 and/or work surface 16 for positioning the work surface and tool relative to one another in one, two, or three dimensions and/or along two or three orthogonal axes. In some examples, a separate drive motor 25 of the drive mechanism 24 may be provided for positioning the tool and work surface relative to one another along each of at least two orthogonal axes or each of three orthogonal axes (i.e., parallel to the X, Y, and Z axes). Each drive motor 25 may include any suitable motor controllable to position work surface 16 (or tool 14) with precision sufficient to support the function(s) of instrument 10. In some examples, each drive motor 25 includes a stepper motor. In some examples, each drive motor 25 includes a servomotor.

The instrument also includes a control module 26. A control module, as used herein, may include any combination or all of the controllers/processors of the instrument, associated devices/circuitry, a sensor (e.g., a voltage sensor), and/or any memory/instructions associated with or accessible by the controllers/processors. The control module may be in communication with, and/or configured/programmed to control operation of, any suitable combination of the devices of the instrument, such as tool 14, reader 22, and/or drive mechanism 24, among others. Accordingly, the state/configuration of each drive motor 25 of drive mechanism 24 may be controlled by control module 26.

The control module 26 may store or otherwise have access to information regarding the relationship between positions of the motors and the location of the driven work surface (and/or driven tool) within a coordinate system. Accordingly, drive signals may be passed from the control module to the drive mechanism to reposition the work surface (or tool) to selected X, Y, and/or Z coordinates.

The coordinates at which the control module places the work surface must be accurately correlated with the actual physical position of the work surface with respect to the tool. For example, the control module may assume there is a point in physical space where the tip of the tool is located, which may have coordinates 0, 0, 0. Similarly, there may be a configuration of the drive mechanism in which the control module assumes that a point on the work surface has been placed at the same coordinates (0, 0, 0). (In other words, the control module assumes the tool and the work surface are in contact with one another.) These two points should be essentially identical for the work surface to be positioned accurately with respect to the tool tip by the drive mechanism. Accordingly, if, for example, the drive mechanism moves the work surface into contact with the tip of the tool, and the internally-calculated coordinates of the work surface indicate that contact should not have been made, the instrument is out of calibration.

Based on this principle, and taking into account that work surface 16 and tool 14 are conductive, a calibration module or continuity circuit 28 is included in calibration system 12. Calibration module 28 may include an electrical circuit having a resistive voltage divider, as explained in detail below. Control module 26 may sense and monitor an electrical property of the circuit to detect a change in the property. The change indicates that tool 14 and work surface 16 have come into contact with one another as at least one is moved toward the other. The electrical property may be voltage, current, resistance, capacitance, and/or the like, which may be sensed with a corresponding sensor of the control module.

Work surface 16 can be intentionally driven toward tool 14 along a selected axis, and the point of actual contact can be determined with the aid of the circuit. Detection of contact may be by direct sensing by a motor controller of the control module, where the motor controller directly controls operation of one of the motors of the drive mechanism. Additionally or alternatively, a message-based implementation may include a monitoring device of the control module that is separate from the motor controller and connected by a communication path. In this implementation, each motion axis might be driven by a separate motor controller of the control module, all connected by a common bus. Although slower, since messages must be exchanged between each move, a message-based implementation may allow a single continuity circuit to serve multiple motor controllers, if present.

The point of actual contact then may be compared to the expected point of contact on that axis, and the instrument may be calibrated for that axis based on the difference. The difference may be in terms of a number of motor revolutions or stepper counts, for example, which would then be used to inform the control module, and particularly the appropriate motor controller thereof. For example, it may be determined that the Y axis is off by negative three counts of the stepper motor. Future movements may take this information into account when positioning along the Y axis. More generally, calibration of the instrument, for a given axis, establishes or adjusts a relationship between the drive mechanism and a position of the (driven) tool or (driven) work surface along the axis. The relationship may be stored in the control module, and/or may, for example, define or correspond to a position or configuration of a motor of the drive mechanism at which the tool and work surface contact one another.

Because calibration module 28, tool 14, and work surface 16 are integral parts of instrument 10, no special fixtures or manual procedures are necessary to calibrate the instrument. Accordingly, such calibration can be performed automatically at any suitable frequency or upon the occurrence of any suitable event. For example, calibration can be automatically performed upon each startup, between successive workpieces, daily, on demand, etc., without special user training or additional equipment. Additionally, such a calibration system can detect and possibly correct for anomalous conditions, such as a bent or missing tool tip.

Illustrative Calibration Circuits:

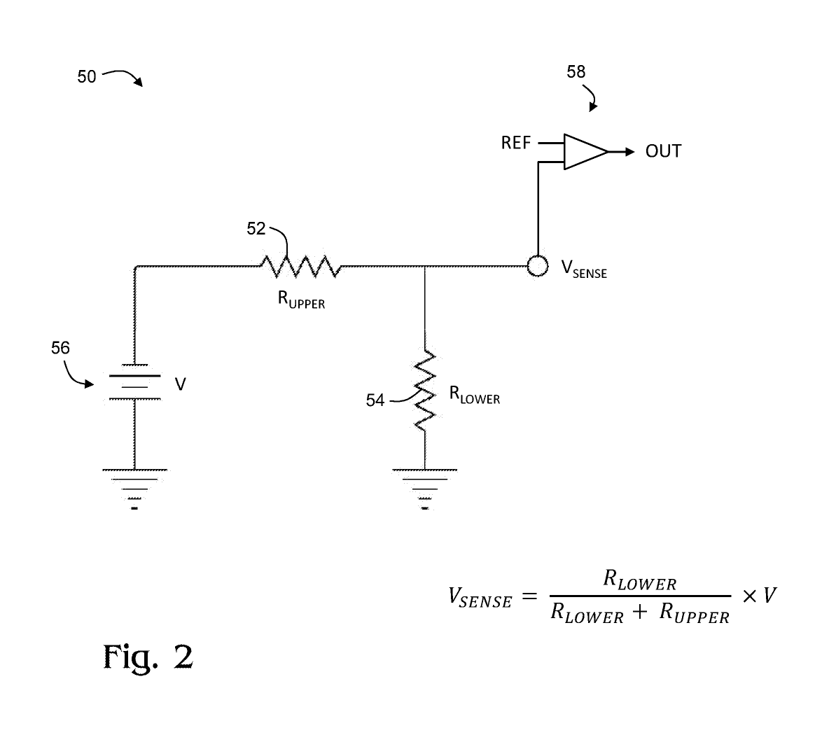

As shown in FIGS. 2-7, this section describes a voltage divider circuit suitable for use in a calibration module such as module 28, and related components. Portions of this circuit may include identical portions of instrument 10, as described above.

With reference to FIG. 2, in general, a voltage divider circuit 50 in this context may include a pair of resistors, namely, an upper resistor 52 having a resistance of R_{UPPER}, and lower resistor 54 having a resistance of R_{LOWER}. The resistors may be arranged in series with a voltage source 56 having a voltage V. Lower resistor 54 is connected to ground, as is voltage source 56, as shown in FIG. 2. A sensed voltage (V_{SENSE}) at the indicated position between the resistors will then have the value of V×R_{LOWER} (R_{LOWER}+R_{UPPER}). However, if lower resistor 54 is not connected to ground, V_{SENSE} will have the value of V. Accordingly, values of R_{LOWER} and R_{UPPER} may be selected such that a detectable change occurs in V_{SENSE} when resistor 54 is connected to ground. It also may be desirable to select values of R_{LOWER} and/or R_{UPPER} such that little to no current flows through resistor 54 when connected to ground. Both of these conditions (detectable change and essentially no current) will occur, for example, when R_{UPPER} is large and much greater than R_{LOWER}.

For example, if R_{UPPER} is 40K Ohms and R_{LOWER} is zero (0) Ohms, and V is five (5) volts, then V_{SENSE} will change from five volts to zero volts upon connection of resistor 54 to ground. Importantly, however, R_{LOWER} can be non-zero and still produce a similar change. For example, if R_{LOWER} is 100 Ohms in the previous example, then V_{SENSE} will change from five volts to 0.0025 volts.

The change in an electrical property of the circuit, such as V_{SENSE}, can be detected with a comparator circuit 58 of the control module, which compares V_{SENSE} to a reference value and produces an output signal based on the comparison. For example, if V_{SENSE} is less than a threshold value, an output may be produced indicating that lower resistor 54 is connected to ground. A comparator is used in this example to describe the functionality of circuit 58. Any suitable comparator-like circuit may be utilized to detect a change in V_{SENSE}.

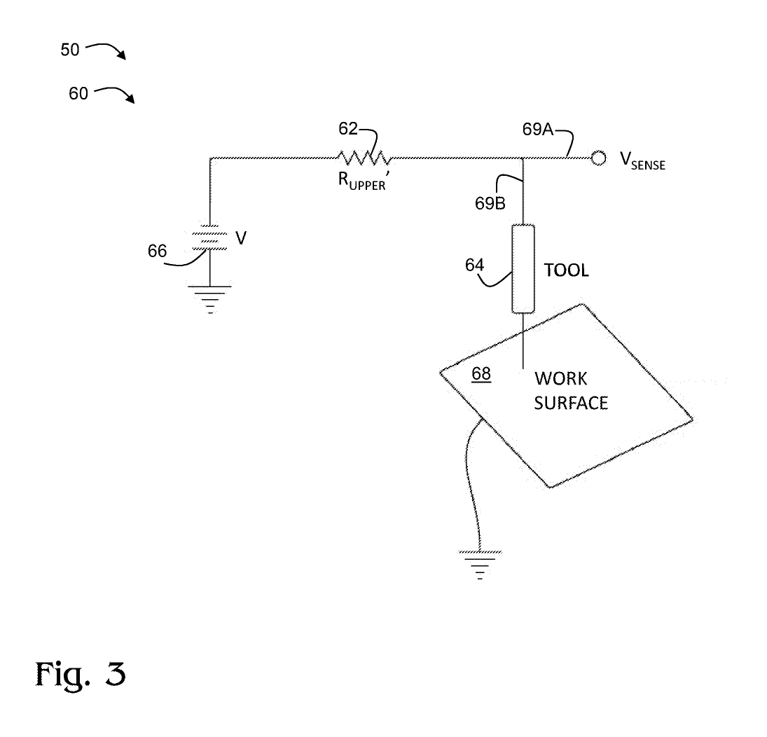

Turning to FIGS. 3-5, a specific example of circuit 50 is shown and generally indicated at 60. In this example, an upper resistor 62 having a resistance of R_{UPPER}′ is arranged in electrical series with a tool 64 and a voltage source 66. Tool 64 is a specific embodiment of lower resistor 54 of circuit 50 in FIG. 2, and is assumed to have a resistance value of R_{LOWER}′ that is near zero relative to R_{UPPER}′. A grounded work surface 68 may selectively contact tool 64. Accordingly, contact between tool 64 and work surface 68 will connect tool 64 to ground. Tool 64 and work surface 68 are examples of tool 14 and work surface 16, respectively, and are substantially as described above.

Circuit 50 may branch at a position between upper resistor 62 and tool 64, to form a pair of branches 69A, 69B (see FIG. 3). An electrical property of circuit 50 may be sensed via branch 69A. Branch 69B may have an open position in which tool 64 and work surface 68 are not in contact, and a closed position in which the tool and work surface are in contact with one another. The sensed electrical property of circuit 50 changes significantly, as described above, when branch 69B changes from the open position to the closed position, or vice versa.

In some examples, voltage source 66 may have a voltage of less than about 10, 7, or 5 volts, among others, such as approximately 3.3 volts. In some examples, R_{UPPER}′ may be greater than about 1K, 2K, 5K, or 10K Ohms, among others, such as approximately 20K or 40K Ohms. In some examples, R_{LOWER}′ may be less than about 10K, 5K, 2K, 1K, 0.5K or 0.2K Ohms, among others, such as approximately 1K Ohms.

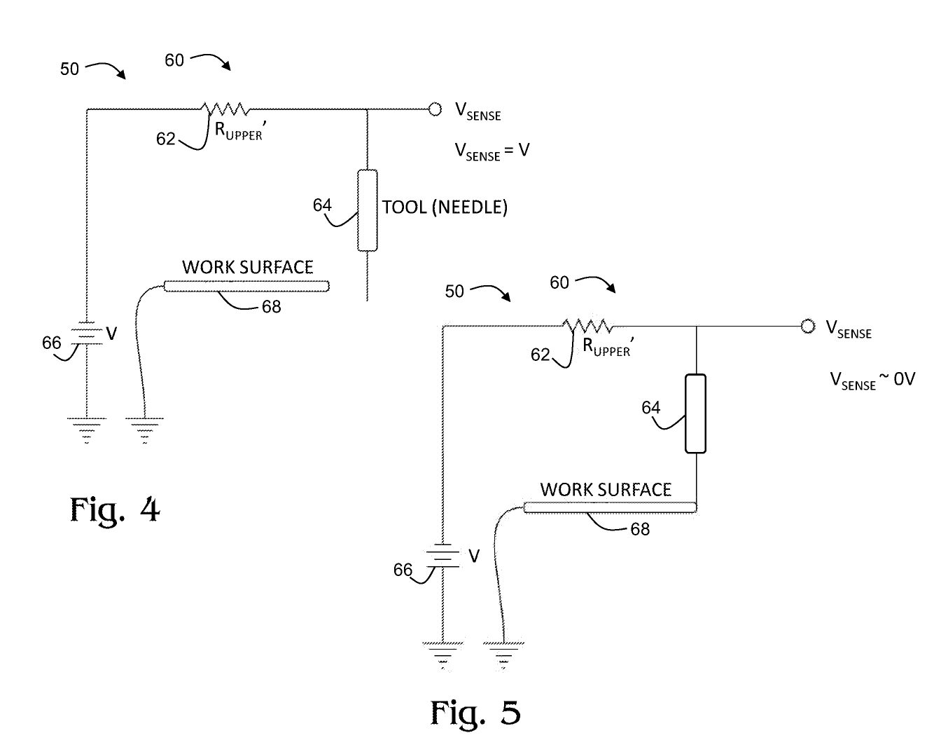

Based on the above description, a difference in V_{SENSE} may occur between a first condition, in which tool 64 is not in contact with surface 68 (see FIG. 4) and a second condition, in which tool 64 is in contact with surface 68 (see FIG. 5). In a possibly ideal situation, tool 64 has a negligible resistance.

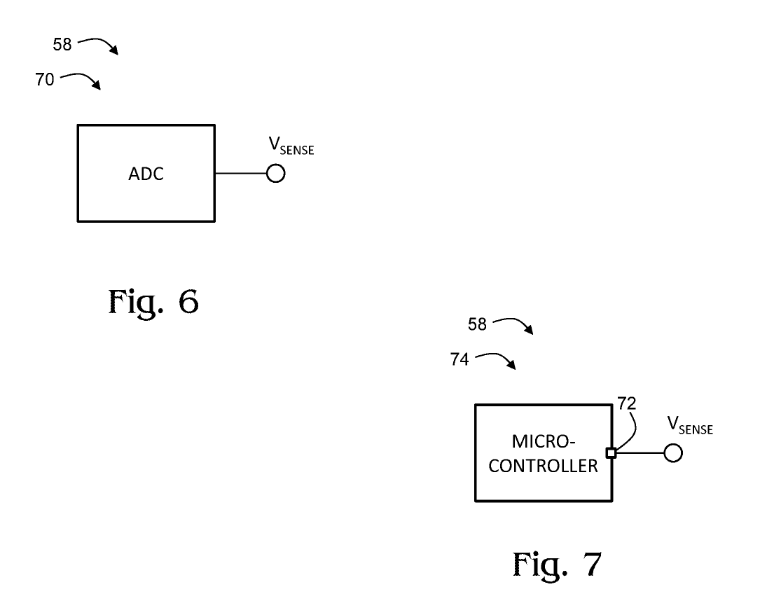

As described above, various circuits may be used to detect a change in V_{SENSE}. In a first example, an analog comparator may be used, as described with respect to FIG. 2. In a second example, V_{SENSE} may be electrically connected to an analog-to-digital converter (ADC) 70, as shown in FIG. 6. In this example, a standard clamping diode arrangement may be utilized to protect the ADC. If the digital value of the voltage falls below a selected threshold value, contact between the tool and the work surface can be inferred. In a third example, V_{SENSE} may be measured by inductive coupling to a sensor circuit (i.e., without electrical connection to V_{SENSE}).

In a fourth example, V_{SENSE} may be electrically connected to an input pin 72 of a microcontroller 74 having a power supply voltage of V_{DD}, as shown in FIG. 7. Reliable detection of a change in V_{SENSE} may be possible when V_{SENSE} is at most twenty percent of V_{DD} when the tool is connected to ground. Given a known value of R_{UPPER}′, a maximum value of R_{LOWER}′ (the resistance of tool 64) may therefore be calculated to provide reliable detection. Similarly, a minimum value of R_{UPPER}′ may be calculated based on a known tool resistance.

For example, given a V_{DD} of five volts, the most V_{SENSE} should be when the tool is grounded is one volt (i.e., 20% of five). Accordingly, if R_{UPPER}′ is 100K Ohms, the maximum value of tool resistance is 25K Ohms, based on the V_{SENSE} formula described above and in FIG. 2. Said another way, R_{LOWER}′ should be at most one-fourth (i.e., less than about 25%) of R_{UPPER}′ to ensure reliable detection of the change in V_{SENSE} when grounding the tool. Tool resistance is typically in the hundreds of Ohms, at most, giving a comfortable margin of error in this example.

Illustrative Method:

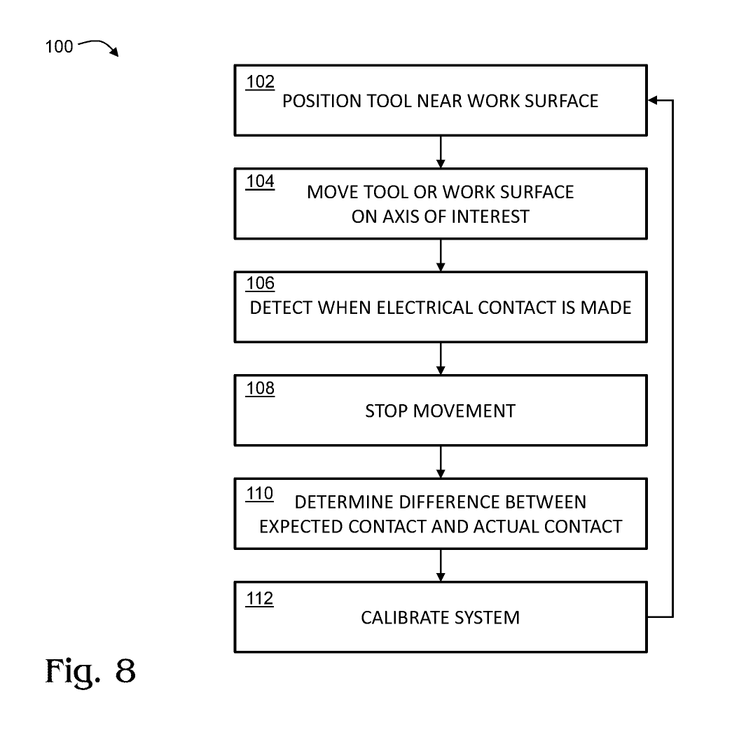

This section describes steps of an illustrative method for automatically calibrating an instrument having a tool and a work surface, each of which is at least partially conductive; see FIG. 8. Any suitable aspects of direct-contact instrument calibration systems and voltage divider circuits, as described above, may be utilized in the method steps described below. Where appropriate, reference may be made to previously described components and systems that may be used in carrying out each step. These references are for illustration, and are not intended to limit the possible ways of carrying out any particular step of the method.

FIG. 8 is a flowchart illustrating steps performed in an illustrative method, and may not recite the complete process or all steps of the method. FIG. 8 depicts multiple steps of a method, generally indicated at 100, which may be performed in conjunction with instrument calibration systems according to aspects of the present disclosure. Although various steps of method 100 are described below and depicted in FIG. 8, the steps need not necessarily all be performed, and in some cases may be performed in a different order than the order shown.

At step 102, the tool of an instrument may be brought to a position near a work surface, by operation of a drive mechanism. For example, tool 14 may be brought into proximity with work surface 16, based on nominal system calibration values. The relative positions of the tool and work surface may be selected based on an axis of interest. For example, the tool and work surface may be separated along the X axis.

At step 104, the tool or work surface (as the case may be) may be moved together along the axis of interest, by operation of the drive mechanism. For example, work surface 16 may be moved slowly by operating the X axis drive motor 24. The work surface may be offset from the tool in a selected direction, and the direction of movement then may be chosen such that the work surface moves toward the tool.

At step 106, contact between the work surface and the tool may be detected using a module comprising a resistive voltage divider circuit. For example, a calibration module 28 may be utilized, including a circuit such as circuit 50 or 60. For example, a drop in the magnitude of sensed voltage (e.g., V_{SENSE}) below a selected threshold value may indicate contact between the work surface and the tool, as explained above.

At step 108, relative movement between the tool and the work surface is stopped. For example, if the work surface was moving toward the tool, the system would stop the work surface immediately upon indication that electrical contact has been made (see step 106). To prevent damage, the tool and work surface may be moved apart immediately as well.

At step 110, the point of actual contact, determined in step 106, may be compared to a point of expected contact. For example, the internal coordinate system of the control module may indicate that contact should have been made at a certain point, but the motor had to be driven a number of counts beyond that point before making contact. Or in some examples, contact may be made earlier than expected. That number of counts and the direction of the error/offset may be calculated, recorded, and/or determined in step 110.

At step 112, the system may be calibrated based on the difference determined in step 110. For example, an offset may be applied to the axis of interest based on the number and direction of revolutions or counts needed to bring that drive motor into calibration.

The steps above may be repeated for each applicable axis of interest.

### Selected Embodiments

This section describes additional aspects and features of direct contact instrument calibration systems and methods, presented without limitation as a series of paragraphs, which are alphanumerically designated for clarity and efficiency. Each of these paragraphs can be combined with one or more other paragraphs, and/or with disclosure from elsewhere in this application, including any materials listed in the Cross-References, in any suitable manner. Some of the paragraphs below may expressly refer to and further limit other paragraphs, providing without limitation examples of some of the suitable combinations.

Paragraph A0. A device comprising any feature described herein, either individually or in combination with any other such feature, in any configuration.

Paragraph B0. A process for instrument calibration, the process comprising any process step described herein, in any order, using any modality.

Paragraph C0. An instrument having a calibration system, comprising: (i) a conductive work surface connected to an electrical ground; (ii) a conductive tool configured to manipulate a workpiece supported on the work surface; (iii) a drive motor operatively connected to either the work surface or the tool, such that operation of the drive motor causes relative movement between the work surface and the tool; and (iv) a calibration module including a resistive voltage divider circuit having a resistor and a voltage source, the resistor and the voltage source being arranged in electrical series with the conductive tool; wherein a resistance of the resistor is at least approximately four times greater than a resistance of the tool.

Paragraph C1. The instrument of paragraph C0, wherein the tool is stationary and the work surface is controllably positionable by the drive motor.

Paragraph C2. The instrument of paragraph C0 or C1, wherein a voltage sensed at a point between the resistor and the tool is in electrical communication with a comparator circuit.

Paragraph C3. The instrument of paragraph C2, wherein the comparator circuit is configured to provide an output signal when the sensed voltage is less than a reference value.

Paragraph C4. The instrument of paragraph C3, wherein mechanical contact between the tool and the work surface causes the sensed voltage to fall below the reference value.

Paragraph C5. The instrument of any of paragraphs C0 to C4, wherein the resistance of the resistor is greater than about 1,000 Ohms and the resistance of the tool is less than about 1,000 Ohms.

Paragraph C6. The instrument of C5, wherein the resistance of the resistor is greater than about 20,000 Ohms.

Paragraph C7. The instrument of any of paragraphs C0 to C6, the workpiece further including a first registration feature corresponding to a second registration feature on the work surface.

Paragraph C8. The instrument of C7, wherein the first and second registration features are configured to mate together to positively locate the workpiece relative to the work surface.

Paragraph D0. An instrument having a calibration system, comprising: (i) a support member including an electrically grounded, conductive surface; (ii) a fluid-transport device including an electrically conductive tube having an open end; (iii) a drive mechanism including a motor that is operable to drive movement of the surface of the support member and the tube relative to one another along an axis and into contact with one another; (iv) an electrical circuit including a voltage source and the tube; and (v) a control module in communication with the drive mechanism and the circuit, and configured to calibrate a relationship between the drive mechanism and a position of the tube or the surface along the axis, based on a sensed change in an electrical property of the circuit that occurs when the tube and the surface contact one another.

Paragraph D1. The instrument of paragraph D0, wherein the drive mechanism is operable to drive movement of the surface of the support member and the tube relative to one another in three dimensions.

Paragraph D2. The instrument of paragraph D1, wherein the drive mechanism is operable to drive movement of the surface of the support member and the tube relative to one another along each axis of a pair of orthogonal axes, and wherein the control module is configured to separately calibrate a relationship between the drive mechanism and a position of the tube or the surface along each of the orthogonal axes.

Paragraph D3. The instrument of paragraph D2, wherein the drive mechanism includes respective motors to drive movement of the surface of the support member and the tube relative to one another along each of three orthogonal axes.

Paragraph D4. The instrument of any of paragraphs D0 to D3, wherein the circuit includes a resistor arranged in series with the voltage source and the tube.

Paragraph D5. The instrument of paragraph D4, wherein the circuit branches between the resistor and the tube to form a first branch and a second branch, wherein the tube is included in the first branch, and wherein the control module is configured to sense an electrical property via the second branch.

Paragraph D6. The instrument of paragraph D5, wherein the first branch of the circuit is open when the tube is spaced from the surface of the support member and is closed when the tube contacts the surface of the support member.

Paragraph D7. The instrument of any of paragraphs D0 to D6, further comprising a sample holder configured to be supported on the support member and having a well to hold fluid, wherein the control module is configured to send a drive signal to the drive mechanism that places the open end of the tube into the well.

Paragraph D8. The instrument of paragraph D7, wherein the sample holder is configured to be mated with the support member to positively locate the sample holder.

Paragraph D9. The instrument of paragraph D7 or D8, wherein the open end of the tube forms a port at which fluid enters the fluid-transport device, and wherein the fluid-transport device is configured to aspirate fluid from the well via the open end of the tube.

Paragraph D10. The instrument of any of paragraphs D7 to D9, wherein the sample holder includes an array of wells, and wherein the control module is configured to control placement of the open end of the tube into each of the wells by operation of the drive mechanism.

Paragraph D11. The instrument of any of paragraphs D0 to D10, wherein the fluid-transport device includes a source of positive or negative pressure operatively connected to the tube.

Paragraph D12. The instrument of any of paragraphs D0 to D11, further comprising any of the limitations of paragraphs C0 to C8.

Paragraph D13. The instrument of any of paragraphs D0 to D12, wherein the control module includes a sensor of the electrical property.

Paragraph D14. The instrument of paragraph D13, wherein the sensor is a voltage sensor.

Paragraph D15. The instrument of paragraph D13 or D14, wherein the sensor is electrically connected to the circuit.

Paragraph D16. The instrument of paragraph D13 or D14, wherein the sensor is inductively coupled to the circuit.

Paragraph D17. The instrument of any of paragraphs D13 to D16, wherein the sensor includes a comparator.

Paragraph D18. An instrument having a calibration system, comprising: (i) a support member including an electrically grounded, conductive surface; (ii) a sample holder configured to be disposed on the support member and having a well; (iii) a pipettor including an electrically conductive tube having an open end that forms a port at which fluid enters the pipettor; (iv) a drive mechanism including a plurality of motors that are operable to drive movement of the surface of the support member and the tube relative to, and into contact with, one another along each of three orthogonal axes; (v) a voltage divider circuit including a voltage source, a resistor, and the tube connected in series; and (vi) a control module in communication with the drive mechanism and the circuit and configured to separately calibrate a relationship between the drive mechanism and a position of the tube or the surface along each of the three orthogonal axes based on a change in an electrical property of the voltage divider circuit that occurs when the tube and the surface contact one another, and to control operation of the drive mechanism to place the open end of the tube into the well.

Paragraph E0. A method of calibrating an instrument having a tool and a work surface, the method comprising, in any order: (i) positioning an electrically conductive tool near a grounded, electrically conductive work surface; (ii) moving the tool and/or work surface along a selected axis, such that the tool and work surface will come into mechanical contact; (iii) detecting when the tool and the work surface come into contact using a resistive voltage divider circuit comprising a resistor in electrical series with the tool and a voltage source; (iv) stopping movement of the tool or work surface in response to detecting contact; (v) determining a difference between an actual contact point and an expected contact point; and (vi) calibrating the selected axis based on the difference.

Paragraph E1. The method of paragraph E0, wherein the selected axis is a first selected axis, the method further including repeating each of the steps for a second selected axis.

Paragraph E2. The method of paragraph E1, wherein the second selected axis is orthogonal to the first axis.

Paragraph E3. The method of paragraph E2, wherein the second selected axis is a vertical axis.

Paragraph E4. The method of any of paragraph E0 to E3, wherein positioning the tool near the work surface is based on nominal calibration values.

Paragraph E5. The method of any of paragraphs E0 to E4, wherein the resistor of the resistive voltage divider circuit has a resistance at least four times greater than a resistance of the tool.

Paragraph E6. The method of any of paragraphs E0 to E5, wherein moving the tool or work surface comprises moving the work surface using a stepper motor.

Paragraph F0. A method of calibrating an instrument, the method comprising, in any order: (i) positioning an electrically conductive tube of a fluid-transport device near a grounded, electrically conductive surface; (ii) moving the tube and surface relative to one another along an axis with a drive mechanism until the tube and the surface come into mechanical contact with one another; (iii) detecting when the tube and the surface come into mechanical contact by sensing an electrical property of a circuit including a voltage source and the tube; and (iv) calibrating a relationship between the drive mechanism and a position of the tube or the surface along the axis based on the step of detecting.

Paragraph F1. The method of paragraph F0, further comprising a step of transporting fluid through the tube.

Paragraph F2. The method of paragraph F0 or F1, wherein the step of detecting is performed using a resistive voltage divider circuit comprising a resistor in electrical series with the tube and the voltage source, and wherein the resistance of the resistor is greater than about 1,000 Ohms.

Paragraph F3. The method of any of paragraphs F0 to F2, further comprising a step of stopping movement of the tube and the surface relative to one another when the mechanical contact is detected.

Paragraph F4. The method of any of paragraphs F0 to F3, further comprising a step of determining a difference between an actual contact point and an expected contact point of the mechanical contact, wherein the step of calibrating is based on the difference.

Paragraph F5. The method of any of paragraphs F0 to F4, where the axis is a first axis, the method further comprising repeating each of the steps for a second axis that is orthogonal to the first axis.

Paragraph F6. The method of any of paragraphs F0 to F5, wherein the step of positioning is based on nominal calibration values.

Paragraph F7. The method of any of paragraphs F0 to F6, further comprising steps of placing a sample holder on the surface; placing an open end of the tube into a well of the sample holder by operation of the drive mechanism; and aspirating fluid from the well into the tube.

Advantages, Features, Benefits

The different embodiments and examples of the instrument calibration systems and methods described herein may provide one or more advantages over known solutions for calibrating instruments. For example, illustrative embodiments and examples described herein may allow automatic calibration using contact between a conductive tool and a conductive work surface. Additionally, and among other benefits, illustrative embodiments and examples described herein may eliminate the need for an additional calibration fixture. Additionally, and among other benefits, illustrative embodiments and examples described herein may allow an unambiguous calibration by utilizing the actual objects and locations of interest as opposed to sensors, flags, and/or fixtures. Additionally, and among other benefits, illustrative embodiments and examples described herein may allow a tool having a non-zero resistance. Additionally, and among other benefits, illustrative embodiments and examples described herein may allow a single detection circuit to be used for multiple axes and drive motors. Additionally, and among other benefits, illustrative embodiments and examples described herein may allow automatic detection of anomalous conditions, such as a bent or missing tool tip.

No known system or device can perform these functions. Thus, the illustrative embodiments and examples described herein are particularly useful for instruments used in PCR processes. However, not all embodiments and examples described herein provide the same advantages or the same degree of advantage.

### CONCLUSION

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure. Further, ordinal indicators, such as first, second, or third, for identified elements are used to distinguish between the elements, and do not indicate a particular position or order of such elements, unless otherwise specifically stated.

Explicit reference is hereby made to all examples, embodiments, inventions, labels, terms, descriptions, and illustrative measurements shown in the drawings and/or in any included appendices, whether or not described further herein. To the extent that section headings are used within this disclosure, such headings are for organizational purposes only.

We claim:

1. An instrument having a calibration system, comprising:
a support member including an electrically grounded, conductive surface;
a fluid-transport device including an electrically conductive tube having an open end;
a drive mechanism including a motor that is operable to drive movement of the surface of the support member and the tube relative to one another along an axis and into contact with one another;
a circuit including a voltage source and the tube; and
a control module in communication with the drive mechanism and the circuit, and configured to calibrate a relationship between the drive mechanism and a position of the tube or the surface along the axis, based on a sensed change in an electrical property of the circuit that occurs when the tube and the surface contact one another.

2. The instrument of claim 1, wherein the drive mechanism is operable to drive movement of the surface of the support member and the tube relative to one another in three dimensions.

3. The instrument of claim 2, wherein the drive mechanism is operable to drive movement of the surface of the support member and the tube relative to one another along each axis of a pair of orthogonal axes, and wherein the control module is configured to separately calibrate a relationship between the drive mechanism and a position of the tube or the surface along each of the orthogonal axes.

4. The instrument of claim 3, wherein the drive mechanism includes respective motors to drive movement of the surface of the support member and the tube relative to one another along each of three orthogonal axes.

5. The instrument of claim 1, wherein the circuit includes a resistor arranged in series with the voltage source and the tube.

6. The instrument of claim 5, wherein the circuit branches between the resistor and the tube to form a first branch and a second branch, wherein the tube is included in the first branch, and wherein the control module is configured to sense the electrical property via the second branch.

7. The instrument of claim 6, wherein the first branch of the circuit is open when the tube is spaced from the surface of the support member and is closed when the tube contacts the surface of the support member.

8. The instrument of claim 1, further comprising a sample holder configured to be supported on the support member and having a well to hold fluid, wherein the control module is configured to send a drive signal to the drive mechanism that places the open end of the tube into the well.

9. The instrument of claim 8, wherein the sample holder is configured to be mated with the support member to positively locate the sample holder.

10. The instrument of claim 8, wherein the open end of the tube forms a port at which fluid enters the fluid-transport device, and wherein the fluid-transport device is configured to aspirate fluid from the well via the open end of the tube.

11. The instrument of claim 8, wherein the sample holder includes an array of wells, and wherein the control module is configured to control placement of the open end of the tube into each of the wells by operation of the drive mechanism.

12. The instrument of claim 1, wherein the fluid-transport device includes a source of positive or negative pressure operatively connected to the tube.

13. An instrument having a calibration system, comprising:
a support member including an electrically grounded, conductive surface;
a sample holder configured to be disposed on the support member and having a well;
a pipettor including an electrically conductive tube having an open end that forms a port at which fluid enters the pipettor;
a drive mechanism including a plurality of motors that are operable to drive movement of the surface of the support member and the tube relative to, and into contact with, one another along each of three orthogonal axes;
a voltage divider circuit including a voltage source, a resistor, and the tube connected in series; and
a control module in communication with the drive mechanism and the circuit and configured to separately calibrate a relationship between the drive mechanism and a position of the tube or the surface along each of the three orthogonal axes based on a change in an electrical property of the voltage divider circuit that occurs when the tube and the surface contact one another, and to control operation of the drive mechanism to place the open end of the tube into the well.

14. A method of calibrating an instrument, the method comprising, in any order:
positioning an electrically conductive tube of a fluid-transport device near a grounded, electrically conductive surface;
moving the tube and surface relative to one another along an axis with a drive mechanism until the tube and the surface come into mechanical contact with one another;
detecting when the tube and the surface come into mechanical contact by sensing an electrical property of a circuit including a voltage source and the tube; and
calibrating a relationship between the drive mechanism and a position of the tube or the surface along the axis based on the step of detecting.

15. The method of claim 14, further comprising a step of transporting fluid through the tube.

16. The method of claim 14, wherein the step of detecting is performed using a resistive voltage divider circuit comprising a resistor in electrical series with the tube and the voltage source, and wherein the resistance of the resistor is greater than about 1,000 Ohms.

17. The method of claim 14, further comprising a step of stopping movement of the tube and the surface relative to one another when the mechanical contact is detected.

18. The method of claim 14, further comprising a step of determining a difference between an actual contact point and an expected contact point of the mechanical contact, wherein the step of calibrating is based on the difference.

19. The method of claim 14, where the axis is a first axis, the method further comprising repeating each of the steps for a second axis that is orthogonal to the first axis.

20. The method of claim 14, wherein the step of positioning is based on nominal calibration values.

21. The method of claim 14, further comprising steps of
placing a sample holder on the surface;
placing an open end of the tube into a well of the sample holder by operation of the drive mechanism; and
aspirating fluid from the well into the tube.
